(19) United States
(12) Patent Application Publication
(10) Pub. No.: US 2006/0234859 A1
(43) Pub. Date: Oct. 19, 2006

(54) Process for producing catalyst for production of acetic acid, catalyst for production of acetic acid obtained by the production process and process for producing acetic acid using the catalyst

(76) Inventors: Yoshiaki Obana, Fukushima (JP); Meiko Saihata, Oita (JP); Seiji Sato, Oita (JP); Kenji Yamada, Oita (JP); Tetsuo Nakajo, Oita (JP)

Correspondence Address: SUGHRUE MION, PLLC, 2100 PENNSYLVANIA AVENUE, N.W., SUITE 800, WASHINGTON, DC, 20037, US

(21) Appl. No.: 10/564,440

(22) PCT Filed: Jul. 16, 2004
(86) PCT No.: PCT/JP04/10584

§ 371 Date: Jan. 12, 2006

Related U.S. Application Data
(60) Provisional application No. 60/499,073, filed on Sep. 2, 2003.

(30) Foreign Application Priority Data
Aug. 25, 2003 (JP) 2003-208665

(51) Int. Cl. B01J 21/00; B01J 23/42; B01J 27/185

(52) U.S. Cl. 502/213; 502/255; 502/262

(57) ABSTRACT

A process for producing a catalyst for the production of acetic acid, used in a process for producing acetic acid from ethylene and oxygen and comprising a support having supported thereon palladium and at least one compound selected from the group consisting of heteropolyacids and salts thereof, where a catalyst capable of ensuring production of acetic acid with higher activity and less reduction in the performance accompanying changes in aging can be obtained, wherein palladium is loaded in parts and through at least two steps.

### CROSS-REFERENCE TO RELATED APPLICATION

This application is an application filed under 35 U.S.C. §111(a) claiming benefit, pursuant to 35 U.S.C. §119(e)(1), of the filing date of the Provisional Application 60/499,073 filed Sep. 2, 2003, pursuant to 35 U.S.C. §111(b).

### TECHNICAL FIELD

The present invention relates to a process for producing a catalyst for the production of acetic acid, the catalyst comprising a support having supported thereon palladium and at least one member selected from heteropolyacids and salts thereof, which catalyst is used for producing acetic acid from ethylene and oxygen in a gas phase. The present invention also relates to a catalyst for the production of acetic acid obtained by the production process and a process for producing acetic acid by using the catalyst.

More specifically, the present invention relates to a process for producing a catalyst comprising a support having supported thereon palladium and at least one member selected from the group consisting of heteropolyacids and salts thereof, where the supported state of palladium is controlled by loading palladium through a plurality of steps.

### BACKGROUND ART

The process for producing acetic acid from ethylene through single stage has many advantageous points in view of an industrial production process and the profitability thereof and a large number of proposals have been made regarding such a process. Specifically, there have been proposed, for example, a liquid phase single-stage oxidation process using an oxidation-reduction catalyst of metal ion pair such as palladium-cobalt and palladium-iron (see, French Patent No. 1,448,361), a process using a catalyst comprising palladium-phosphoric acid or sulfur-containing modifying agent (see, Japanese Unexamined Patent Publications No. 47-013221 (JP-A-47-013221) and No. 51-029425 (JP-A-51-029425)), and a gas phase single-stage oxidation process using a catalyst comprising a 3-group system oxygen compound (see, Japanese Examined Patent Publication No. 46-006763 (JP-B-46-006763)). Also, as the process for producing acetic acid by using a catalyst containing a palladium compound and a heteropolyacid, a gas phase single-stage oxidation process using a catalyst comprising a palladium phosphovanadomolybdate has been proposed in Japanese Unexamined Patent Publication No. 54-57488 (JP-A-54-57488).

In recent years, a process for producing acetic acid from ethylene and oxygen through a gas phase single stage by using a catalyst comprising palladium and at least one compound selected from heteropolyacids and salts thereof has been proposed (see, Japanese Unexamined Patent Publications No. 7-89896 (JP-A-7-89896) and No. 9-67298 (JP-A-9-67298)). According to the process using this catalyst, the acetic acid can be obtained in a relatively high yield. It is disclosed that the catalyst containing palladium and at least one compound selected from the group consisting of heteropolyacids and salts thereof, which is used for the synthesis of acetic acid from ethylene and oxygen, expresses very high activity and selectivity by virtue of the interaction between palladium metal and heteropolyacid and exhibits excellent activity and selectivity for the production of acetic acid.

Furthermore, for example, Japanese Unexamined Patent Publications No. 11-347412 (JP-A-11-347412) and No. 2000-308830 (JP-A-2000-308830), WO00/051725 and WO00/061535 disclose improved processes regarding a catalyst for use in producing acetic acid through direct oxidation of ethylene by using a catalyst comprising, as essential components, palladium and at least one compound selected from the group consisting of heteropolyacids and salts thereof, a production process of the catalyst, and a process for producing acetic acid by using the catalyst.

In conventionally proposed processes for producing acetic acid from ethylene and oxygen though a gas phase single stage, the catalyst comprising palladium and at least one compound selected from the group consisting of heteropolyacids and salts thereof exhibits sufficiently high performance in view of practice in industrial scale. However, if the catalytic activity can be more enhanced, this is advantageous in view of profitability.

Conventionally disclosed processes for producing a catalyst comprising a support having supported thereon palladium and at least one compound selected from the group consisting of heteropolyacids and salts thereof are fundamentally characterized by comprising the following steps.

First Step

A step of loading palladium on a support to produce a palladium-supported catalyst.

Second Step

A step of loading a heteropolyacid or a heteropolyacid salt on the palladium-supported catalyst obtained in the first step to obtain a catalyst for the production of acetic acid.

In this process, the step of loading palladium is preferably performed once in view of the process and the characteristic feature is that, subsequent to the step of producing a palladium-supported catalyst, another step of loading a heteropolyacid or a heteropolyacid salt is provided.

Furthermore, it is thought that an eggshell-type palladium catalyst is advantageous as the catalyst obtained in the first step of obtaining a palladium-supported catalyst. The eggshell type indicates a type where the palladium-supporting position in the support is present in the outer side of the support. The reason why the eggshell type is effective is considered because the reaction matrix scarcely diffuses into the center or inner region of the catalyst support and the metal component supported in the vicinity of inner or center region of the support cannot greatly contribute to the reaction. Also, JP-A-7-89896 discloses that a production process for a palladium-supported catalyst, comprising an alkali treatment step using sodium metasilicate or the like, is advantageous for obtaining an eggshell-type palladium catalyst. In addition, JP-A-2000-308830 discloses that a production process for a palladium-supported catalyst, comprising a barium salt treatment step using barium hydroxide or the like, is advantageous for obtaining an eggshell-type palladium catalyst.

That is, conventionally disclosed processes for producing a catalyst for the production of acetic acid are characterized in that palladium is loaded on a support to obtain a palladium-supported catalyst and then, a heteropolyacid or a heteropolyacid salt is loaded.

### DISCLOSURE OF THE INVENTION

An object of the present invention is to provide a process for producing a catalyst for the production of acetic acid, the catalyst being used in a process for producing acetic acid from ethylene and oxygen and comprising a support having supported thereon palladium and at least one compound selected from the group consisting of heteropolyacids and salts thereof, where a catalyst capable of ensuring production of acetic acid with a higher activity and a lower reduction in performance accompanying changes in aging can be obtained.

In a reaction of obtaining acetic acid from ethylene and oxygen in the presence of a catalyst comprising palladium and a heteropolyacid, it is unlikely that each of the palladium and the heteropolyacid acts individually, but an interaction therebetween is considered to cause the expression of high selectivity and productivity.

AS for the conventional process for producing a catalyst for the production of acetic acid, the catalyst, which is used for obtaining acetic acid from ethylene and oxygen, comprising a support having supported thereon palladium and at least one compound selected from the group consisting of heteropolyacids and salts thereof, there has been disclosed a process of loading palladium and a heteropolyacid or a heteropolyacid salt on a support at different timings. More specifically, this process comprises a step of loading palladium on a support and a step of loading a heteropolyacid or a heteropolyacid salt on the obtained palladium-supported catalyst. In this case, these two members, microscopically, do not form a completely uniform contact with each other and may not interacting. Particularly, in the disclosed process for producing a catalyst for the production of acetic acid, the palladium-supported catalyst is produced by using a process of dipping the catalyst in an alkali treating solution and then reducing it and the palladium-supporting position in the support is an eggshell type. On the other hand, the heteropolyacid or heteropolyacid salt is uniformly supported in the entire support and therefore, the center part of the support has a region where palladium is not present and only a heteropolyacid or a heteropolyacid salt is present. That is, the heteropolyacid or heteropolyacid salt supported in the center part may not contribute to the reaction.

In order to enhance the catalytic performance, the present inventors have taken notice of the positions of palladium and heteropolyacid or heteropolyacid salt in the catalyst for the production of acetic acid, produced by conventionally disclosed processes for the production of a catalyst.

As a result of intensive investigations to solve the above-described problems, the present inventors have found that, in a process for producing a supported catalyst comprising, as essential components, (a) palladium and (b) at least one compound selected from heteropolyacids and salts thereof, which catalyst is used in a process for producing acetic acid from ethylene and oxygen, when a process for producing a catalyst for the production of acetic acid, comprising loading palladium in parts through at least two steps is used, surprisingly, the obtained catalyst for the production of acetic acid can yield higher productivity and particularly, can be prevented from changes in aging of the catalytic performance. The present invention has been accomplished based on this finding.

That is, the present invention (I) is a process for producing a catalyst for the production of acetic acid, the catalyst being a supported catalyst which is used in a process for producing acetic acid by reacting ethylene and oxygen in a gas phase and comprises (a) palladium and (b) at least one compound selected from the group consisting of heteropolyacids and salts thereof, the process comprising loading palladium in parts through at least two steps.

The present invention (II) is a process for producing a catalyst for the production of acetic acid, the catalyst being a supported catalyst which is used in a process for producing acetic acid by reacting ethylene and oxygen in a gas phase and comprises (a) palladium, (b) at least one compound selected from the group consisting of heteropolyacids and salts thereof and (c) at least one element selected from the group consisting of Sn, Pb, Bi, Sb and Te, the process comprising loading the palladium, in parts, through at least two steps.

The present invention (III) is a process for producing a catalyst for the production of acetic acid, the catalyst being a supported catalyst which is used in a process for producing acetic acid by reacting ethylene and oxygen in a gas phase and comprises (a) palladium, (b) at least one compound selected from the group consisting of heteropolyacids and salts thereof, (c) at least one element selected from the group consisting of Sn, Pb, Bi, Sb and Te and (d) at least one element selected from the group consisting of Cr, Mn, Fe, Ru, Co, Cu, Au and Zn, the process comprising loading palladium in parts through at least two steps.

The present invention (IV) is a process for producing a catalyst for the production of acetic acid, the catalyst being a supported catalyst which is used in a process for producing acetic acid by reacting ethylene and oxygen in a gas phase and comprises (a) palladium, (b) at least one compound selected from the group consisting of heteropolyacids and salts thereof, (c) at least one element selected from the group consisting of Sn, Pb, Bi, Sb and Te, (d) at least one element selected from the group consisting of Cr, Mn, Fe, Ru, Co, Cu, Au and Zn and (e) at least one element selected from the group consisting of V and Mo, the process comprising loading palladium in parts through at least two steps.

The present invention (V) is a catalyst for the production of acetic acid, which is obtained by the process for producing a catalyst for the production of acetic acid of the present invention (I), (II), (III) or (IV).

The present invention (VI) is a process for producing acetic acid by using the catalyst for the production of acetic acid of the present invention (V).

Accordingly, the present invention comprises, for example, the following matters.

[1] A process for producing a catalyst for the production of acetic acid, the catalyst being a supported catalyst which is used in a process for producing acetic acid by reacting ethylene and oxygen in a gas phase and comprises (a) palladium and (b) at least one compound selected from the group consisting of heteropolyacids and salts thereof, the process comprising loading palladium in parts through at least two steps.

[2] The process for producing a catalyst for the production of acetic acid as described in [1] above, which comprises the following first and second steps:

First Step:

a step of loading (a) palladium on a support to obtain a palladium-supported catalyst;

Second Step:

a step of loading (a) palladium and (b) at least one compound selected from the group consisting of heteropolyacids and salts thereof on the palladium-supported catalyst obtained in the first step to obtain a catalyst for the production of acetic acid.

[3] A process for producing a catalyst for the production of acetic acid, the catalyst being a supported catalyst which is used in a process for producing acetic acid by reacting ethylene and oxygen in a gas phase and comprises (a) palladium, (b) at least one compound selected from the group consisting of heteropolyacids and salts thereof and (c) at least one element selected from the group consisting of Sn, Pb, Bi, Sb and Te, the process comprising loading palladium in parts through at least two steps.

[4] The process for producing a catalyst for the production of acetic acid as described in [3] above, which comprises the following first and second steps:

First Step:

a step of loading (a) palladium and (c) at least one element selected from the group consisting of Sn, Pb, Bi, Sb and Te on a support to obtain a palladium-supported catalyst;

Second Step:

a step of loading (a) palladium and (b) at least one compound selected from the group consisting of heteropolyacids and salts thereof on the palladium-supported catalyst containing an element of the group (c) obtained in the first step to obtain a catalyst for the production of acetic acid.

[5] The process for producing a catalyst for the production of acetic acid as described in [3] above, which comprises the following first and second steps:

First Step:

a step of loading (a) palladium on a support to obtain a palladium-supported catalyst;

Second Step:

a step of loading (a) palladium, (b) at least one compound selected from the group consisting of heteropolyacids and salts thereof and (c) at least one element selected from the group consisting of Sn, Pb, Bi, Sb and Te on the palladium-supported catalyst obtained in the first step to obtain a catalyst for the production of acetic acid.

[6] The process for producing a catalyst for the production of acetic acid as described in [3] above, which comprises the following first, second and third steps:

First Step:

a step of loading (a) palladium on a support to obtain a palladium-supported catalyst;

Second Step:

a step of loading (c) at least one element selected from the group consisting of Sn, Pb, Bi, Sb and Te on the palladium-supported catalyst obtained in the first step to obtain a palladium-supported catalyst containing an element of the group (c);

Third Step:

a step of loading (a) palladium and (b) at least one compound selected from the group consisting of heteropolyacids and salts thereof on the palladium-supported catalyst containing an element of the group (c) obtained in the second step to obtain a catalyst for the production of acetic acid.

[7] A process for producing a catalyst for the production of acetic acid, the catalyst being a supported catalyst which is used in a process for producing acetic acid by reacting ethylene and oxygen in a gas phase and comprises (a) palladium, (b) at least one compound selected from the group consisting of heteropolyacids and salts thereof, (c) at least one element selected from the group consisting of Sn, Pb, Bi, Sb and Te and (d) at least one element selected from the group consisting of Cr, Mn, Fe, Ru, Co, Cu, Au and Zn, the process comprising loading the palladium, in parts, through at least two steps.

[8] The process for producing a catalyst for the production of acetic acid as described in [7] above, which comprises the following first and second steps:

First Step:

a step of loading (a) palladium, (c) at least one element selected from the group consisting of Sn, Pb, Bi, Sb and Te and (d) at least one element selected from the group consisting of Cr, Mn, Fe, Ru, Co, Cu, Au and Zn on a support to obtain a palladium-supported catalyst;

Second Step:

a step of loading (a) palladium and (b) at least one compound selected from the group consisting of heteropolyacids and salts thereof on the palladium-supported catalyst containing an element of the group (c) and an element of the group (d) obtained in the first step to obtain a catalyst for the production of acetic acid.

[9] The process for producing a catalyst for the production of acetic acid as described in [7] above, which comprises the following first and second steps:

First Step:

a step of loading (a) palladium and (c) at least one element selected from the group consisting of Sn, Pb, Bi, Sb and Te on a support to obtain a palladium-supported catalyst;

Second Step:

a step of loading (a) palladium, (b) at least one compound selected from the group consisting of heteropolyacids and salts thereof and (d) at least one element selected from the group consisting of Cr, Mn, Fe, Ru, Co, Cu, Au and Zn on the palladium-supported catalyst containing an element of the group (c) obtained in the first step to obtain a catalyst for the production of acetic acid.

[10] The process for producing a catalyst for the production of acetic acid as described in [7] above, which comprises the following first and second steps:

First Step:

a step of loading (a) palladium and (d) at least one element selected from the group consisting of Cr, Mn, Fe, Ru, Co, Cu, Au and Zn on a support to obtain a palladium-supported catalyst;

Second Step:

a step of loading (a) palladium, (b) at least one compound selected from the group consisting of heteropolyacids and salts thereof and (c) at least one element selected from the group consisting of Sn, Pb, Bi, Sb and Te on the palladium-supported catalyst containing an element of the group (d) obtained in the first step to obtain a catalyst for the production of acetic acid.

[11] The process for producing a catalyst for the production of acetic acid as described in [7] above, which comprises the following first and second steps:

First Step:

a step of loading (a) palladium on a support to obtain a palladium-supported catalyst;

Second Step:

a step of loading (a) palladium, (b) at least one compound selected from the group consisting of heteropolyacids and salts thereof, (c) at least one element selected from the group consisting of Sn, Pb, Bi, Sb and Te and (d) at least one element selected from the group consisting of Cr, Mn, Fe, Ru, Co, Cu, Au and Zn on the palladium-supported catalyst obtained in the first step to obtain a catalyst for the production of acetic acid.

[12] The process for producing a catalyst for the production of acetic acid as described in [7] above, which comprises the following first, second and third steps:

First Step:

a step of loading (a) palladium and (d) at least one element selected from the group consisting of Cr, Mn, Fe, Ru, Co, Cu, Au and Zn on a support to obtain a palladium-supported catalyst;

Second Step:

a step of loading (c) at least one element selected from the group consisting of Sn, Pb, Bi, Sb and Te on the palladium-supported catalyst containing an element of the group (d) obtained in the first step to obtain a palladium-supported catalyst containing an element of the group (c) and an element of the group (d);

Third Step:

a step of loading (a) palladium and (b) at least one compound selected from the group consisting of heteropolyacids and salts thereof on the palladium-supported catalyst containing an element of the group (c) and an element of the group (d) obtained in the second step to obtain a catalyst for the production of acetic acid.

[13] The process for producing a catalyst for the production of acetic acid as described in [7] above, which comprises the following first, second and third steps:

First Step:

a step of loading (a) palladium on a support to obtain a palladium-supported catalyst;

Second Step:

a step of loading (.c) at least one element selected from the group consisting of Sn, Pb, Bi, Sb and Te on the palladium-supported catalyst obtained in the first step to obtain a palladium-supported catalyst containing an element of the group (c);

Third Step:

a step of loading (a) palladium, (b) at least one compound selected from the group consisting of heteropolyacids and salts thereof and (d) at least one element selected from the group consisting of Cr, Mn, Fe, Ru, Co, Cu, Au and Zn on the palladium-supported catalyst containing an element of the group (c) obtained in the second step to obtain a catalyst for the production of acetic acid.

[14] A process for producing a catalyst for the production of acetic acid, the catalyst being a supported catalyst which is used in a process for producing acetic acid by reacting ethylene and oxygen in a gas phase and comprises (a) palladium, (b) at least one compound selected from the group consisting of heteropolyacids and salts thereof, (c) at least one element selected from the group consisting of Sn, Pb, Bi, Sb and Te, (d) at least one element selected from the group consisting of Cr, Mn, Fe, Ru, Co, Cu, Au and Zn and (e) at least one element selected from the group consisting of v and Mo, the process comprising loading the palladium, in parts, through at least two steps.

[15] The process for producing a catalyst for the production of acetic acid as described in [14] above, which comprises the following first and second steps:

First Step:

a step of loading (a) palladium, (c) at least one element selected from the group consisting of Sn, Pb, Bi, Sb and Te and (d) at least one element selected from the group consisting of Cr, Mn, Fe, Ru, Co, Cu, Au and Zn on a support to obtain a palladium-supported catalyst;

Second Step:

a step of loading (a) palladium, (b) at least one compound selected from the group consisting of heteropolyacids and salts thereof and (e) at least one element selected from the group consisting of V and Mo on the palladium-supported catalyst containing an element of the group (c) and an element of the group (d) obtained in the first step to obtain a catalyst for the production of acetic acid.

[16] The process for producing a catalyst for the production of acetic acid as described in [14] above, which comprises the following first and second steps:

First Step:

a step of loading (a) palladium and (c) at least one element selected from the group consisting of Sn, Pb, Bi, Sb and Te on a support to obtain a palladium-supported catalyst;

Second Step:

a step of loading (a) palladium, (b) at least one compound selected from the group consisting of heteropolyacids and salts thereof, (d) at least one element selected from the group consisting of Cr, Mn, Fe, Ru, Co, Cu, Au and Zn and (e) at least one element selected from the group consisting of V and Mo on the palladium-supported catalyst containing an element of the group (c) obtained in the first step to obtain a catalyst for the production of acetic acid.

[17] The process for producing a catalyst for the production of acetic acid as described in [14] above, which comprises the following first and second steps:

First Step:

a step of loading (a) palladium and (d) at least one element selected from the group consisting of Cr, Mn, Fe, Ru, Co, Cu, Au and Zn on a support to obtain a palladium-supported catalyst;

Second Step:

a step of loading (a) palladium, (b) at least one compound selected from the group consisting of heteropolyacids and salts thereof, (c) at least one element selected from the group consisting of Sn, Pb, Bi, Sb and Te and (e) at least one element selected from the group consisting of v and Mo on the palladium-supported catalyst containing an element of the group (d) obtained in the first step to obtain a catalyst for the production of acetic acid.

[18] The process for producing a catalyst for the production of acetic acid as described in [14] above, which comprises the following first and second steps:

First Step:

a step of loading (a) palladium on a support to obtain a palladium-supported catalyst;

Second Step:

a step of loading (a) palladium, (b) at least one compound selected from the group consisting of heteropolyacids and salts thereof, (c) at least one element selected from the group consisting of Sn, Pb, Bi, Sb and Te, (d) at least one element selected from the group consisting of Cr, Mn, Fe, Ru, Co, Cu, Au and Zn and (e) at least one element selected from the group consisting of V and Mo on the palladium-supported catalyst obtained in the first step to obtain a catalyst for the production of acetic acid.

[19] The process for producing a catalyst for the production of acetic acid as described in [14] above, which comprises the following first, second and third steps:

First Step:

a step of loading (a) palladium and (d) at least one element selected from the group consisting of Cr, Mn, Fe, Ru, Co, Cu, Au and Zn on a support to obtain a palladium-supported catalyst;

Second Step:

a step of loading (c) at least one element selected from the group consisting of Sn, Pb, Bi, Sb and Te on the palladium-supported catalyst containing an element of the group (d) obtained in the first step to obtain a palladium-supported catalyst containing an element of the group (c) and an element of the group (d);

Third Step:

a step of loading (a) palladium, (b) at least one compound selected from the group consisting of heteropolyacids and salts thereof and (e) at least one element selected from the group consisting of V and Mo on the palladium-supported catalyst containing an element of the group (c) and an element of the group (d) obtained in the second step to obtain a catalyst for the production of acetic acid.

[20] The process for producing a catalyst for the production of acetic acid as described in [14] above, which comprises the following first, second and third steps:

First Step:

a step of loading (a) palladium on a support to obtain a palladium-supported catalyst;

Second Step:

a step of loading (c) at least one element selected from the group consisting of Sn, Pb, Bi, Sb and Te on the palladium-supported catalyst obtained in the first step to obtain a palladium-supported catalyst containing an element of the group (c);

Third Step:

a step of loading (a) palladium, (b) at least one compound selected from the group consisting of heteropolyacids and salts thereof, (d) at least one element selected from the group consisting of Cr, Mn, Fe, Ru, Co, Cu, Au and Zn and (e) at least one element selected from the group consisting of V and Mo on the palladium-supported catalyst containing an element of the group (c) obtained in the second step to obtain a catalyst for the production of acetic acid.

[21] The process for producing a catalyst for the production of acetic acid as described in [2], [5], [6], [11], [13], [18] or [20] above, wherein the first step further comprises the following first-1, first-2 and first-3 steps:

First-1 Step:

a step of loading (a) a palladium compound on a support to obtain a palladium-supported catalyst;

First-2 Step:

a step of dipping the palladium-supported catalyst obtained in the first-1 step in an aqueous alkali solution;

First-3 Step:

a step of reducing the palladium-supported catalyst obtained in the first-2 step to obtain a metal palladium-supported catalyst.

[22] The process for producing a catalyst for the production of acetic acid as described in [4], [9] or [16] above, wherein the first step further comprises the following first-1, first-2 and first-3 steps:

First-1 Step:

a step of loading (a) a palladium compound and (c) at least one element selected from the group consisting of Sn, Pb, Bi, Sb and Te on a support to obtain a palladium-supported catalyst;

First-2 Step:

a step of dipping the palladium-supported catalyst containing an element of the group (c) obtained in the first-1 step in an aqueous alkali solution;

First-3 Step:

a step of reducing the palladium-supported catalyst containing an element of the group (c) obtained in the first-2 step to obtain a metal palladium-supported catalyst containing an element of the group (c).

[23] The process for producing a catalyst for the production of acetic acid as described in [10], [12], [17] or [19] above, wherein the first step further comprises the following first-1, first-2 and first-3 steps:

First-1 Step:

a step of loading (a) a palladium compound and (d) at least one element selected from the group consisting of Cr, Mn, Fe, Ru, Co, Cu, Au and Zn on a support to obtain a palladium-supported catalyst;

First-2 Step:

a step of dipping the palladium-supported catalyst containing an element of the group (d) obtained in the first-1 step in an aqueous alkali solution;

First-3 Step:

a step of reducing the palladium-supported catalyst containing an element of the group (d) obtained in the first-2 step to obtain a metal palladium-supported catalyst containing an element of the group (d).

[24] The process for producing a catalyst for the production of acetic acid as described in [8] or [15] above, wherein the first step further comprises the following first-1, first-2 and first-3 steps:

First-1 Step;

a step of loading (a) a palladium compound, (c) at least one element selected from the group consisting of Sn, Pb, Bi, Sb and Te and (d) at least one element selected from the group consisting of Cr, Mn, Fe, Ru, Co, Cu, Au and Zn on a support to obtain a palladium-supported catalyst;

First-2 Step:

a step of dipping the palladium-supported catalyst containing an element of the group (c) and an element of the group (d) obtained in the first-1 step in an aqueous alkali solution;

First-3 Step:

a step of reducing the palladium-supported catalyst containing an element of the group (c) and an element of the group (d) obtained in the first-2 step to obtain a metal palladium-supported catalyst containing an element of the group (c) and an element of the group (d).

[25] The process for producing a catalyst for the production of acetic acid as described in any one of [1] to [24] above, wherein (b) the heteropolyacid or a salt thereof is selected from the following heteropolyacids and salts thereof:

1-12-phosphotungstic acid: H₃[PW₁₂O₄₀]·nH₂O

1-12-silicotungstic acid: H₄[SiW₁₂O₄₀]·nH₂O wherein n represents an integer of 0 to 40.

[26] A catalyst for the production of acetic acid, which is obtained by the process for producing a catalyst for the production of acetic acid described in any one of [1] to [25] above.

[27] A process for producing acetic acid, comprising reacting ethylene and oxygen in a gas phase in the presence of the catalyst for the production of acetic acid described in [26] obtained by the process for producing a catalyst for the production of acetic acid.

### BRIEF DESCRIPTION OF THE DRAWINGS

FIG. 1 is a view showing changes in a reaction after aging in the production of acetic acid using the catalysts for the production of acetic acid obtained in Examples 2 and Comparative Example 2.

FIG. 2 is a chart showing EPMA analysis results of Si in the catalyst for the production of acetic acid obtained in Example 1.

FIG. 3 is a chart showing EPMA analysis results of Pd in the catalyst for the production of acetic acid obtained in Example 1.

FIG. 4 is a chart showing EPMA analysis results of tungsten in the catalyst for the production of acetic acid obtained in Example 1.

FIG. 5 is a chart showing EPMA analysis results of Si in the catalyst for the production of acetic acid obtained in Comparative Example 1.

FIG. 6 is a chart showing EPMA analysis results of Pd in the catalyst for the production of acetic acid obtained in Comparative Example 1.

FIG. 7 is a chart showing EPMA analysis results of tungsten in the catalyst for the production of acetic acid obtained in Comparative Example 1.

### BEST MODE FOR CARRYING OUT THE INVENTION

The preferred embodiments of the present invention are described below.

Present Invention (I)—Process for Producing Catalyst for Production of Acetic Acid The process for producing a catalyst for the production of acetic acid of the present invention (I) is described below.

The process for producing a catalyst for the production of acetic acid of the present invention (I) is a process for producing a catalyst for the production of acetic acid, the catalyst being a supported catalyst which is used in a process for producing acetic acid by reacting ethylene and oxygen in a gas phase and comprises (a) palladium and (b) at least one compound selected from the group consisting of heteropolyacids and salts thereof, the process comprising loading palladium in parts through at least two steps.

This production process preferably comprises the following first and second steps:

First Step:

a step of loading (a) palladium on a support to obtain a palladium-supported catalyst;

Second Step:

a step of loading (a) a palladium compound and (b) at least one compound selected from the group consisting of heteropolyacids and salts thereof on the palladium-supported catalyst obtained in the first step to obtain a catalyst for the production of acetic acid.

First Step of Present Invention (I)

The first step is a step of loading (a) palladium on a support to obtain a palladium-supported catalyst

The support for use in the present invention (I) is not particularly limited and a porous substance commonly used as a support may be used. Preferred examples of the support include silica, silica-alumina, diatomaceous earth, montmorillonite and titania, with silica being more preferred. The shape of the support is not particularly limited and specific examples thereof include a powder form, a spherical form and a pellet form, but the present invention is not limited thereto.

The particle size of the support for use in the present invention (I) is not particularly limited, but in the case of use in a tubular reactor of a fixed bed, when the support is spherical, the particle preferably has a diameter of 1 to 10 mm, more preferably from 2 to 8 mm. In the case of performing the reaction by filling the catalyst in a tubular reactor, if the particle diameter is less than 1 mm, a great pressure loss may be generated on passing of a gas and the gas may not be effectively circulated, whereas if the particle diameter exceeds 10 mm, a reaction gas may not diffuse into the inside of catalyst and the catalytic reaction may not effectively proceed. As for the pore structure of the support, the pore diameter is preferably from 1 to 1,000 nm, more preferably from 2 to 800 nm.

In the present invention (I), the supported catalyst indicates a catalyst in the state that (a) palladium and (b) at least one compound selected from the group consisting of heteropolyacids and salts thereof are held on a support.

The palladium (a) loaded in the present invention (I) may be in any state, for example, may be in the state of a compound or an element as it is, that is, may be in an ionic state or a so-called metal state with 0 valence, but is preferably in a metal state.

In the first step, the raw material compound of (a) palladium is not particularly limited. Specific examples thereof include metal palladium, halides (e.g., palladium chloride), organic acid salts (e.g., palladium acetate), nitrates (e.g., palladium nitrate), palladium oxide, sodium tetrachloropalladate and potassium tetrachloropalladate. A complex containing, as a ligand, an organic compound such as acetylacetonate, nitrite and ammonium, may also be used. Among these, preferred are sodium tetrachloropalladate, potassium tetrachloropalladate and palladium nitrate.

In the case of obtaining an eggshell-type palladium-supported catalyst, the method for loading (a) palladium on a support is not particularly limited insofar as an eggshell-type palladium-supported catalyst can be finally obtained. The eggshell-type catalyst is one of active component distribution states in the support particle or shaped body and indicates a state where the active component is present only on the outer surface of a support particle or shaped body. Specific examples of the method for producing a catalyst of this type include a method of dissolving the raw material compound in an appropriate solvent such as water and acetone, an inorganic or organic acid such as hydrochloric acid, nitric acid and acetic acid, or a solution thereof, and loading the component directly or indirectly on the surface layer. Examples of the direct loading method include an impregnation method and a spray method, and examples of the indirect loading method include a method of treating the catalyst with an alkali and then reducing it.

The operation of converting (a) palladium into a metal state may be performed after isolating the catalyst having supported thereon (a) palladium or may be performed subsequently to the loading operation. Also, a method of reducing only a part of the palladium loaded but not entirely reducing the palladium may be used. Examples of the reducing agent used include hydrazine, hydrogen and ethylene.

The supported state of palladium on a support is preferably a so-called “eggshell type”.

In order to obtain an eggshell-type palladium-supported catalyst in the first step, one preferred example of the method therefor comprises the following steps:

First-1 Step:

a step of loading (a) a palladium compound on a support to obtain a palladium-supported catalyst;

First-2 Step:

a step of dipping the palladium-supported catalyst obtained in the first-1 step in an aqueous alkali solution; and

First-3 Step:

a step of reducing the palladium-supported catalyst obtained in the first-2 step to obtain a metal palladium-supported catalyst.

The aqueous alkali solution for use in the first-2 step may be an aqueous solution of an alkali such as sodium hydroxide, sodium metasilicate and/or barium hydroxide. In this step, the palladium compound may be partially and/or entirely converted into an oxide or a hydroxide.

The first-3 step is a step of reducing the palladium compound into a metal palladium after conversion into an oxide or a hydroxide. The operation of converting (a) palladium into a metal state may be performed after isolating the catalyst having supported thereon (a) palladium or may be performed subsequently to the loading operation. Examples of the reducing agent used include hydrazine, hydrogen and ethylene.

In this way, (a) a palladium-supported catalyst can be obtained.

Second Step of Present Invention (I)

The second step of the present invention (I) is a step of loading (a) palladium and (b) at least one compound selected from the group consisting of heteropolyacids and salts thereof on the palladium-supported catalyst obtained in the first step to obtain a catalyst for the production of acetic acid. That is, in this step, a palladium component is further loaded on the palladium-supported catalyst.

The palladium (a) for use in the second step of the present invention (I) is not particularly limited. Specific examples thereof include metal organic acid salts such as palladium acetate, and nitrates such as palladium nitrate. Also, complexes containing, as a ligand, an organic compound such as acetylacetonate, nitrile and ammonium, may be used. This palladium is preferably a palladium compound not containing chlorine and being dissolvable in an acidic aqueous solution. Examples thereof include palladium nitrate and palladium acetate. If the catalyst for the production of acetic acid is produced by using a halide such as palladium chloride, chloropalladic acid and sodium tetrachloropalladate, unless the halogen is thoroughly removed from the catalyst, the halogen passes through the reaction tube at the start of reaction or during reaction to cause corrosion. It is difficult to completely remove the halogen by ordinary methods, and, for example, the catalyst must be disadvantageously washed with an aqueous solution or heated at a high temperature for a long time.

The heteropolyacid (b) for use in the second step of the present invention (I) is preferably a heteropolyacid comprising tungsten as the poly-atom. As for the heteroatom, examples thereof include, but are not limited to, phosphorus, silicon, boron, aluminum, germanium, titanium, zirconium, cerium, cobalt and chromium. Among these, preferred are phosphorus, silicon and boron. Specific preferred examples of the heteropolyacid include silicotungstic acid, phosphotungstic acid and borotungstic acid, with silicotungstic acid and phosphotungstic acid being more preferred. Furthermore, heteropolyacids known as having a Keggin structure, represented by the following chemical formulae, are preferred in practice, but it is not necessary that the heteropolyacids on the catalyst all have this structure.

1-12-phosphotungstic acid: H₃[PW₁₂O₄₀]·nH₂O

1-12-silicotungstic acid: H₄[SiW₁₂O₄₀]·nH₂O wherein n represents an integer of 0 to 40.

The heteropolyacid salt (b) for use in the catalyst of the present invention (I) is a metal or onium salt where hydrogen atoms of an acid produced by condensing two or more inorganic oxygen acids are partially or entirely substituted. The metal substituted to hydrogen atoms of the heteropolyacid is preferably at least one element selected from the group consisting of elements belonging to Groups 1, 2, 11 and 13 of the Periodic Table. Examples of the onium salt of the heteropolyacid include ammonium salts. Among these heteropolyacid salts, preferred are metal salts with lithium, sodium, potassium, cesium, magnesium, barium, copper, gold or gallium.

Examples of the heteropolyacid salt which is preferred in view of catalytic performance and practical use include, but are not limited to, lithium phosphotungstate, sodium phosphotungstate, copper phosphotungstate, lithium silicotungstate, sodium silicotungstate and copper silicotungstate.

Examples of the method for loading (a) palladium and (b) at least one compound selected from the group consisting of heteropolyacids and salts thereof include, but are not limited to, an impregnation method and a spray method. The solvent for use in the impregnation is preferably a solvent capable of dissolving (a) palladium and (b) at least one compound selected from the group consisting of heteropolyacids and salts thereof. The solvent which can be used is water, an organic solvent or a mixture thereof, preferably water and/or an alcohol.

As for the order of loading, these components may be loaded separately or simultaneously. For the purpose of obtaining the contact effect between palladium and a heteropolyacid or heteropolyacid salt, these components are preferably loaded at the same time.

Examples of the method for loading these components at the same time include a method of preparing a uniform solution containing (a) palladium and (b) at least one compound selected from the group consisting of heteropolyacids and salts thereof, and loading these on a support at the same time. More specifically, (a) a palladium compound and (b) at least one compound selected from the group consisting of heteropolyacids and salts thereof are dissolved in an appropriate solvent such as water and acetone or in an inorganic or organic acid such as hydrochloric acid, nitric acid and acetic acid, to prepare a uniform solution and the solution is impregnated into a support and then dried. Also, a method of preparing a palladium salt of heteropolyacid from (a) palladium and (b) at least one compound selected from the group consisting of heteropolyacids and salts thereof, dissolving the obtained palladium salt of heteropolyacid in an appropriate solvent, and loading the components on a support may be used. Preferred examples of the heteropolyacid for use in the palladium salt of heteropolyacid include

1-12-phosphotungstic acid: H₃[PW₁₂O₄₀]·nH₂O

1-12-silicotungstic acid: H₄[SiW₁₂O₄₀]·nH₂O wherein n represents an integer of 0 to 40. The palladium salt of heteropolyacid can be obtained, for example, by preparing an aqueous solution having dissolved therein palladium nitrate and a heteropolyacid, and drying it.

After (a) palladium and (b) at least one compound selected from the group consisting of heteropolyacids and salts thereof are loaded in the form of a solution, the catalyst may be dried by any method. Examples of the drying method include a method of performing vacuum treatment at a low temperature and a method of removing the solvent by heat treatment in a hot air dryer.

After the loading, the catalyst may be reduced, if desired. The reduction treatment is preferably performed in a gas phase and the conditions therefor are not particularly limited if these are commonly employed reduction conditions.

The reducing agent is not particularly limited but examples thereof include hydrogen, ethylene, methanol and CO. Among these, preferred are hydrogen and ethylene.

In performing the reduction treatment, the temperature at the reduction is not particularly limited, but the catalyst obtained in the first step is preferably heated at a temperature on the order of 50 to 350° C., more preferably from 100 to 300° C. If the reaction is performed at a temperature exceeding 350° C., the heteropolyacid may be thoroughly decomposed and this is not preferred.

The treatment pressure practically advantageous in view of equipment is from 0.0 to 3.0 MPa (gauge pressure), but this is not particularly limited. The treatment pressure is more preferably from 0.1 to 1.5 MPa (gauge pressure).

In the case of passing a gaseous reducing agent, the reducing agent may be used at any concentration and if desired, nitrogen, carbon dioxide or rare gas may be used as a diluent. Also, the reduction may be performed in the presence of vaporized water while introducing ethylene, hydrogen or the like. Furthermore, after the catalyst prepared in the first step is packed into a reactor in the reaction system and reduced with ethylene, oxygen may be further introduced to produce acetic acid from ethylene and oxygen.

In the standard state, the mixed gas containing a gaseous reducing agent is preferably passed on the catalyst at a space velocity (hereinafter referred to as “SV”) of 10 to 15,000 hr⁻¹, more preferably from 100 to 8,000 hr⁻¹.

The treatment form is not particularly limited, but a fixed bed where the above-described catalyst is packed in an anticorrosive reaction tube is preferably used and this is advantageous in view of practical use.

In this way, a catalyst for the production of acetic acid can be obtained by the production process of the present invention (I).

The process for producing a catalyst for the production of acetic acid of the present invention (I) is characterized in that the step of loading palladium is performed multiple times. A method of loading palladium on a support to obtain a palladium-supported catalyst in the first step and further loading palladium and a heteropolyacid or a heteropolyacid salt at the same time in the second step is preferably used.

The ratio of palladium loaded in the first step to palladium loaded in the second step (amount of palladium loaded in the first step/amount of palladium loaded in the second step) is preferably from 30/1 to 1/1, more preferably from 25/1 to 2/1. If the ratio (amount of palladium loaded in the first step/amount of palladium loaded in the second step) exceeds 30/1, the amount of palladium loaded in the second step is small and therefore, the effect may decrease, whereas if the ratio is less than 1/1, the ratio of palladium loaded in the inside of the support increases and due to diffusion control of the reaction matrix, a predetermined reaction amount cannot be obtained.

In the catalyst for the production of acetic acid obtained by the production process of the present invention (I), the composition of (a) palladium and (b) at least one compound selected from the group consisting of heteropolyacids and salts thereof in the catalyst where (a) and (b) are held on a support is not particularly limited. The composition is preferably, in terms of the mass % in the entire catalyst, (a):(b)=0.5 to 2.5 mass %:5 to 50 mass %, more preferably (a):(b)=1.0 to 2.5 mass %:10 to 40 mass %, and within this range, preferred results are obtained.

The amounts loaded and compositional ratio of metal element and heteropolyacid contained in the catalyst for the production of acetic acid produced in the present invention (I) can be exactly determined by chemical analysis such as high-frequency inductively coupled plasma emission spectrometry (hereinafter referred to as “ICP”), X-ray fluorescence analysis (hereinafter referred to as “XRF”) and atomic absorption analysis.

For example, the determination can be performed by a method where a certain amount of the catalyst is ground in a mortar or the like to form a uniform powder, the obtained catalyst powder is added to an acid such as hydrofluoric acid or aqua regia, stirred under heat and thereby dissolved to obtain a uniform solution, the resulting solution is diluted with pure water to an appropriate concentration to provide a solution for analysis, and this solution is quantitatively analyzed by ICP.

Present Invention (II)—Process for Producing Catalyst for Production of Acetic Acid The process for producing a catalyst for the production of acetic acid of the present invention (II) is described below.

The process for producing a catalyst for the production of acetic acid of the present invention (II) is a process for producing a catalyst for the production of acetic acid, the catalyst being a supported catalyst which is used in a process for producing acetic acid by reacting ethylene and oxygen in a gas phase and comprises (a) palladium, (b) at least one compound selected from the group consisting of heteropolyacids and salts thereof and (c) at least one element selected from the group consisting of Sn, Pb, Bi, Sb and Te (hereinafter simply referred to as an “element of the group (c)), the process comprising loading palladium in parts through at least two steps.

This production process preferably comprises the following first and second steps:

First Step:

a step of loading (a) palladium, and an element of the group (c) on a support to obtain a palladium-supported catalyst;

Second Step:

a step of loading (a) palladium and (b) at least one compound selected from the group consisting of heteropolyacids and salts thereof on the palladium-supported catalyst containing an element of the group (c) obtained in the first step to obtain a catalyst for the production of acetic acid,

the following first and second steps:

First Step:

a step of loading (a) palladium on a support to obtain a palladium-supported catalyst;

Second Step:

a step of loading (a) palladium, (b) at least one compound selected from the group consisting of heteropolyacids and salts thereof, and a compound containing an element of the group (c) on the palladium-supported catalyst obtained in the first step to obtain a catalyst for the production of acetic acid, or the following first, second and third steps:

First Step:

a step of loading (a) palladium on a support to obtain a palladium-supported catalyst;

Second Step:

a step of loading a compound containing an element of the group (c) on the palladium-supported catalyst obtained in the first step to obtain a palladium-supported catalyst containing an element of the group (c);

Third Step:

a step of loading (a) palladium and (b) at least one compound selected from the group consisting of heteropolyacids and salts thereof on the palladium-supported catalyst containing an element of the group (c) obtained in the second step to obtain a catalyst for the production of acetic acid.

In order to obtain an eggshell-type palladium-supported catalyst in the first step, one preferred example of the method therefor comprises the following steps:

First-1 Step:

a step of loading (a) a palladium compound, and a compound containing an element of the group (c) on a support to obtain a palladium-supported catalyst;

First-2 Step:

a step of dipping the palladium-supported catalyst containing an element of the group (c) obtained in the first-1 step in an aqueous alkali solution; and

First-3 Step:

a step of reducing the palladium-supported catalyst containing an element of the group (c) obtained in the first-2 step to obtain a metal palladium-supported catalyst containing an element of the group (c).

The present invention (II) is a process for producing a supported catalyst which is used in a process for producing acetic acid by reacting ethylene and oxygen in a gas phase and comprises (a) palladium, (b) at least one compound selected from heteropolyacids and salts thereof, and an element of the group (c).

The present invention (II) is a process where an element of the group (c) is further added in the process for producing a catalyst of the present invention (I).

That is, (a) palladium, (b) at least one compound selected from the group consisting of heteropolyacids and salts thereof, and support may be the same as in the present invention (I). Also, the method for loading these components on a support is the same.

The element of the group (c) for use in the present invention (II) is most preferably Te.

The raw material compound for the element of the group (c) for use in the present invention (II) is not particularly limited. Examples thereof include the element itself, and chloride salts, nitrates, acetates, phosphates, sulfates and oxides each containing the element. Also, complexes and the like containing, as a ligand, an organic material such as acetylacetonate and nitrile, may be used.

The timing of loading the element of the group (c) on a support is not particularly limited. For example, the element may be loaded simultaneously with (a) palladium or simultaneously with (b) at least one compound selected from the group consisting of heteropolyacids and salts thereof, or may be loaded independently. The element is preferably loaded by a method of loading (a) palladium and then loading the element independently, or a method of loading the element simultaneously with (b) at least one compound selected from the group consisting of heteropolyacids and salts thereof.

The ratio of palladium loaded in the first step to palladium loaded in the second step is the same as in the present invention (I).

In the catalyst for the production of acetic acid obtained by the production process of the present invention (II), the composition of (a) palladium, (b) at least one compound selected from the group consisting of heteropolyacids and salts thereof, and an element of the group (c) in the catalyst where (a), (b) and (c) are held on a support is not particularly limited. The composition is preferably, in terms of the mass % in the entire catalyst, (a):(b):(c)=0.5 to 2.5 mass %:5 to 50 mass %:0.05 to 3.0 mass %, more preferably (a):(b):(c)=1.0 to 2.5 mass %:10 to 40 mass %:0.08 to 1.0 mass %, and within this range, preferred results are obtained.

Present Invention (III)—Process for Producing Catalyst for Production of Acetic Acid

The process for producing a catalyst for the production of acetic acid of the present invention (III) is described below.

The process for producing a catalyst for the production of acetic acid of the present invention (III) is a process for producing a catalyst for the production of acetic acid, the catalyst being a supported catalyst which is used in a process for producing acetic acid by reacting ethylene and oxygen in a gas phase and comprises (a) palladium, (b) at least one compound selected from the group consisting of heteropolyacids and salts thereof, an element of the group (c), and (d) at least one element selected from the group consisting of Cr, Mn, Fe, Ru, Co, Cu, Au and Zn (hereinafter referred to as an “element of the group (d)”), the process comprising loading palladium in parts through at least two steps.

This production process preferably comprises the following first and second steps:

First Step:

a step of loading (a) palladium, an element of the group (c) and an element of the group (d) on a support to obtain a palladium-supported catalyst;

Second Step:

a step of loading (a) palladium and (b) at least one compound selected from the group consisting of heteropolyacids and salts thereof on the palladium-supported catalyst containing an element of the group (c) and an element of the group (d) obtained in the first step to obtain a catalyst for the production of acetic acid,

the following first and second steps:

First Step:

a step of loading (a) palladium, and an element of the group (c) on a support to obtain a palladium-supported catalyst;

Second Step:

a step of loading (a) palladium, (b) at least one compound selected from the group consisting of heteropolyacids and salts thereof, and a compound containing an element of the group (d) on the palladium-supported catalyst containing an element of the group (c) obtained in the first step to obtain a catalyst for the production of acetic acid,

the following first and second steps:

First Step:

a step of loading (a) palladium, and an element of the group (d) on a support to obtain a palladium-supported catalyst;

Second Step:

a step of loading (a) palladium, (b) at least one compound selected from the group consisting of heteropolyacids and salts thereof, and a compound containing an element of the group (c) on the palladium-supported catalyst containing an element of the group (d) obtained in the first step to obtain a catalyst for the production of acetic acid,

the following first and second steps:

First Step:

a step of loading (a) palladium on a support to obtain a palladium-supported catalyst;

Second Step:

a step of loading (a) palladium, (b) at least one compound selected from the group consisting of heteropolyacids and salts thereof, an element of the group (c), and an element of the group (d) on the palladium-supported catalyst obtained in the first step to obtain a catalyst for the production of acetic acid, the following first, second and third steps:

First Step:

a step of loading (a) palladium, and an element of the group (d) on a support to obtain a palladium-supported catalyst;

Second Step:

a step of loading a compound containing an element of the group (c) on the palladium-supported catalyst containing an element of the group (d) obtained in the first step to obtain a palladium-supported catalyst containing an element of the group (c) and an element of the group (d);

Third Step:

a step of loading (a) palladium and (b) at least one compound selected from the group consisting of heteropolyacids and salts thereof on the palladium-supported catalyst containing an element of the group (c) and an element of the group (d) obtained in the second step to obtain a catalyst for the production of acetic acid,

or the following first, second and third steps:

First Step:

a step of loading (a) palladium on a support to obtain a palladium-supported catalyst;

Second Step:

a step of loading a compound containing an element of the group (c) on the palladium-supported catalyst obtained in the first step to obtain a palladium-supported catalyst containing an element of the group (c);

Third Step:

a step of loading (a) palladium, (b) at least one compound selected from the group consisting of heteropolyacids and salts thereof, and an element of the group (d) on the palladium-supported catalyst containing an element of the group (c) obtained in the second step to obtain a catalyst for the production of acetic acid.

In order to obtain an eggshell-type palladium-supported catalyst in the first step, one preferred example of the method therefor comprises the following steps:

First-1 Step:

a step of loading (a) a palladium compound, and an element of the group (d) on a support to obtain a palladium-supported catalyst;

First-2 Step:

a step of dipping the palladium-supported catalyst containing an element of the group (d) obtained in the first-1 step in an aqueous alkali solution; and

First-3 Step:

a step of reducing the palladium-supported catalyst containing an element of the group (d) obtained in the first-2 step to obtain a metal palladium-supported catalyst containing an element of the group (d).

The present invention (III) is a process where an element of the group (d) is further added in the process for producing a catalyst of the present invention (II).

That is, the same as in the present invention (II) applies to (a) palladium, (b) at least one compound selected from the group consisting of heteropolyacids and salts thereof, an element of the group (c), and support. Also, the method for loading these components on a support is the same.

The element of the group (d) for use in the present invention (III) is preferably Cr, Au or Zn, more preferably Au or Zn.

The raw material compound for the element of the group (d) for use in the present invention (III) is not particularly limited. Examples thereof include the element itself, and chloride salts, nitrates, acetates, phosphates, sulfates and oxides each containing the element. Also, complexes and the like containing, as a ligand, an organic material such as acetylacetonate and nitrile, may be used.

The timing of loading the element of the group (d) on a support is not particularly limited. For example, the element may be loaded simultaneously with (a) palladium or simultaneously with (b) at least one compound selected from the group consisting of heteropolyacids and salts thereof, or may be loaded independently. The element is preferably loaded simultaneously with the loading of (a) palladium.

The ratio of palladium loaded in the first step to palladium loaded in the second step is the same as in the present invention (I).

In the catalyst for the production of acetic acid obtained by the production process of the present invention (III), the composition of (a) palladium, (b) at least one compound selected from the group consisting of heteropolyacids and salts thereof, an element of the group (c), and an element of the group (d) in the catalyst where (a), (b), (c) and (d) are held on a support is not particularly limited. The composition is preferably, in terms of the mass % in the entire catalyst, (a):(b):(c):(d)=0.5 to 2.5 mass %:5 to 50 mass %:0.05 to 3.0 mass %:0.05 to 3.0 mass %, more preferably (a):(b):(c):(d)=1.0 to 2.5 mass %:10 to 40 mass % 0.08 to 1.0 mass %:0.08 to 1.0 mass %, and within this range, preferred results are obtained.

Present Invention (IV)—Process for Producing Catalyst for Production of Acetic Acid

The process for producing a catalyst for the production of acetic acid of the present invention (IV) is described below.

The process for producing a catalyst for the production of acetic acid of the present invention (IV) is a process for producing a catalyst for the production of acetic acid, the catalyst being a supported catalyst which is used in a process for producing acetic acid by reacting ethylene and oxygen in a gas phase and comprises (a) palladium, (b) at least one compound selected from the group consisting of heteropolyacids and salts thereof, an element of the group (c), an element of the group (d), and (e) at least one element selected from the group consisting of V and Mo (hereinafter referred to as an “element of the group (e)”), the process comprising loading palladium in parts through at least two steps.

This production process preferably comprises the following first and second steps:

First Step:

a step of loading (a) palladium, an element of the group (c), and an element of the group (d) on a support to obtain a palladium-supported catalyst;

Second Step:

a step of loading (a) palladium, (b) at least one compound selected from the group consisting of heteropolyacids and salts thereof, and a compound containing an element of the group (e) on the palladium-supported catalyst containing an element of the group (c) and an element of the group (d) obtained in the first step to obtain a catalyst for the production of acetic acid,

the following first and second steps:

First Step:

a step of loading (a) palladium, and an element of the group (c) on a support to obtain a palladium-supported catalyst;

Second Step:

a step of loading (a) palladium, (b) at least one compound selected from the group consisting of heteropolyacids and salts thereof, a compound containing an element of the group (d), and an element of the group (e) on the palladium-supported catalyst containing an element of the group (c) obtained in the first step to obtain a catalyst for the production of acetic acid,

the following first and second steps:

First Step:

a step of loading (a) palladium, and an element of the group (d) on a support to obtain a palladium-supported catalyst;

Second Step:

a step of loading (a) palladium, (b) at least one compound selected from the group consisting of heteropolyacids and salts thereof, a compound containing an element of the group (c), and an element of the group (e) on the palladium-supported catalyst containing an element of the group (d) obtained in the first step to obtain a catalyst for the production of acetic acid,

the following first and second steps:

First Step:

a step of loading (a) palladium on a support to obtain a palladium-supported catalyst;

Second Step:

a step of loading (a) palladium, (b) at least one compound selected from the group consisting of heteropolyacids and salts thereof, an element of the group (c), a compound containing an element of the group (d), and an element of the group (e) on the palladium-supported catalyst obtained in the first step to obtain a catalyst for the production of acetic acid,

the following first, second and third steps:

First Step:

a step of loading (a) palladium, and an element of the group (d) on a support to obtain a palladium-supported catalyst;

Second Step:

a step of loading a compound containing an element of the group (c) on the palladium-supported catalyst containing an element of the group (d) obtained in the first step to obtain a palladium-supported catalyst containing an element of the group (c) and an element of the group (d);

Third Step:

a step of loading (a) palladium, (b) at least one compound selected from the group consisting of heteropolyacids and salts thereof, and an element of the group (e) on the palladium-supported catalyst containing an element of the group (c) and an element of the group (d) obtained in the second step to obtain a catalyst for the production of acetic acid,

or the following first, second and third steps:

First Step:

a step of loading (a) palladium on a support to obtain a palladium-supported catalyst;

Second Step:

a step of loading a compound containing an element of the group (c) on the palladium-supported catalyst obtained in the first step to obtain a palladium-supported catalyst containing an element of the group (c);

Third Step:

a step of loading (a) palladium, (b) at least one compound selected from the group consisting of heteropolyacids and salts thereof, an element of the group (d), and an element of the group (e) on the palladium-supported catalyst containing an element of the group (c) obtained in the second step to obtain a catalyst for the production of acetic acid.

In order to obtain an eggshell-type palladium-supported catalyst in the first step, one preferred example of the method therefor comprises the following steps:

First-1 Step:

a step of loading (a) a palladium compound, an element of the group (c), and an element of the group (d) on a support to obtain a palladium-supported catalyst;

First-2 Step:

a step of dipping the palladium-supported catalyst containing an element of the group (c) and an element of the group (d) obtained in the first-1 step in an aqueous alkali solution; and

First-3 Step:

a step of reducing the palladium-supported catalyst containing an element of the group (c) and an element of the group (d) obtained in the first-2 step to obtain a metal palladium-supported catalyst containing an element of the group (c) and an element of the group (d).

The present invention (IV) is a process where an element of the group (e) is further added in the process for producing a catalyst of the present invention (III).

That is, (a) palladium, (b) at least one compound selected from the group consisting of heteropolyacids and salts thereof, an element of the group (c), an element of the group (d), and support may be the same as in the present invention (III). Also, the method for loading these components on a support is the same.

The raw material compound for the element of the group (e) for use in the present invention (IV) is not particularly limited. Examples thereof include the element itself, and chloride salts, nitrates, acetates, phosphates, sulfates and oxides each containing the element. Also, complexes and the like containing, as a ligand, an organic material such as acetylacetonate and nitrile, may be used.

The raw material compound for the element of the group (e) may be a heteropolyacid containing V or Mo. Specific examples thereof include the following heteropolyacids, but the heteropolyacid containing V or Mo is not particularly limited:
phosphomolybdic acid: H₃[PMO₁₁O₄₀]·nH₂O
silicomolybdic acid: H₄[SiMo₁₁O₄₀]·nH₂O
silicovanadotungstic acid: H₄₊ₓ[SiVₓW₁₂₋ₓO₄₀]·nH₂O
phosphovanadotungstic acid: H₃₊ₓ[PVₓW₁₂₋ₓO₄₀]·nH₂O
phosphovanadomolybdic: H₃₊ₓ[PVₓMo₁₂₋ₓO₄₀]·nH₂O
silicovanadomolybdic acid: H₄₊ₓ[SiVₓMo₁₂₋ₓO₄₀]·nH₂O
silicomolybdotungstic acid: H₄[SiMoₓW₁₂₋ₓO₄₀]·nH₂O
phosphomolybdotungstic acid: H₃[PMoₓW₁₂₋ₓO₄₀]·nH₂O
wherein n is a positive integer.

Among these, preferred are phosphomolybdic acid, phosphovanadomolybdic acid, silicomolybdic acid and silicovanadomolybdic acid.

The timing of loading the element of the group (e) on a support is not particularly limited. For example, the element may be loaded simultaneously with (a) palladium or simultaneously with (b) at least one compound selected from the group consisting of heteropolyacids and salts thereof, or may be loaded independently. The element is preferably loaded simultaneously with (b) at least one compound selected from the group consisting of heteropolyacids and salts thereof.

The ratio of palladium loaded in the first step to palladium loaded in the second step is the same as in the present invention (I).

In the catalyst for the production of acetic acid obtained by the production process of the present invention (IV), the composition of (a) palladium, (b) at least one compound selected from the group consisting of heteropolyacids and salts thereof, an element of the group (c), an element of the group (d), and an element of the group (e) in the catalyst where (a), (b), (c), (d) and (e) are held on a support is not particularly limited. The composition is preferably, in terms of the mass % in the entire catalyst, (a):(b):(c):(d):(e)=0.5 to 2.5 mass %:5 to 50 mass %:0.05 to 3.0 mass %:0.05 to 3.0 mass %:0.05 to 1.0 mass %, more preferably (a):(b):(c):(d):(e)=1.0 to 2.5 mass %:10 to 40 mass % 0.08 to 1.0 mass %:0.08 to 1.0 mass %:0.1 to 0.8 mass %, and within this range, preferred results are obtained.

Present Invention (V)—Catalyst for the Production of Acetic Acid

The present invention (V) is described below.

The present invention (V) is a catalyst for the production of acetic acid, obtained by the process for producing a catalyst for the production of acetic acid of the present invention (I), (II), (III) or (IV).

In the catalyst of the present invention (V), if produced by using a conventionally disclosed technique, the position of each catalyst component supported in the support is such that the palladium is an eggshell type and the heteropolyacid or heteropolyacid salt is uniformly supported. Therefore, the center part of the support has a region where palladium is not present but only a heteropolyacid or heteropolyacid salt is present and intimate interaction between palladium and a heteropolyacid or heteropolyacid salt is not brought about. In other words, the heteropolyacid or heteropolyacid salt supported may not be effectively used. In the processes for producing a catalyst for the production of acetic acid of the present inventions (I) to (IV), the step of loading palladium is performed twice or more so as to effectively use the catalyst components.

The positions of palladium and heteropolyacid or heteropolyacid salt supported in the support can be known by elemental analysis using, for example, an X-ray microprobe (hereinafter referred to as “EPMA”) method. EPMA is a device of irradiating a solid substance with an electron probe focused to the micron order and performing the elemental analysis or observation of configuration by using the characteristic X ray, reflected electron, secondary electron or the like emitted from the microfine portion. EPMA is described in detail in Tsuguro Kinouchi, EPMA Denshi Probe·Microanalyzer (EPMA Electron Probe·Microanalyzer), 1st ed., 1st imp., Gijutsu Shoin (Mar. 30, 2002).

In the catalyst for the production of acetic acid of the present invention (V), the degree of intimate contact between palladium and a heteropolyacid or heteropolyacid salt can be known by analyzing palladium inside the support or elements (for example, tungsten) contained in the heteropolyacid or heteropolyacid salt by means of EPMA.

Present Invention (VI)—Process for Producing Acetic Acid by Using Catalyst for Production of Acetic Acid

The present invention (VI) is described below.

The present invention (VI) is a process for producing acetic acid from ethylene and oxygen by using a catalyst for the production of acetic acid of the present invention (V).

In the process for producing acetic acid of the present invention (VI), the reaction temperature at the time of reacting ethylene and oxygen to produce acetic acid is not particularly limited. The reaction temperature is preferably from 100 to 300° C., more preferably from 120 to 250° C. The reaction pressure practically advantageous in view of equipment is from 0.0 to 3.0 MPa (gauge pressure), but this is not particularly limited. The reaction pressure is more preferably from 0.1 to 1.5 MPa (gauge pressure).

In the process for producing acetic acid of the present invention (VI), the gas supplied to the reaction system contains ethylene and oxygen and if desired, nitrogen, carbon dioxide or a rare gas may be further used as a diluent.

Based on the entire amount of the gas supplied, ethylene is supplied to the reaction system to account for 5 to 80 vol %, preferably from 8 to 50 vol %, and oxygen is supplied to account for 1 to 15 vol %, preferably from 3 to 12 vol %.

In this reaction system, when water is present in the reaction system, an extremely high effect can be provided on the improvement of the acetic acid-producing activity and selectivity and on the maintenance of the catalytic activity. The water vapor is preferably contained in the reaction gas in an amount of 1 to 50 vol %, more preferably from 5 to 40 vol %.

In the process for producing acetic acid of the present invention (VI), a high-purity ethylene is preferably used as the raw material ethylene, but a lower saturated hydrocarbon such as methane, ethane or propane may be mixed therein. The oxygen may be supplied in the form of oxygen diluted with an inert gas such as nitrogen or carbon dioxide gas, for example, in the form of air, but in the case of circulating the reaction gas, it is generally advantageous to use oxygen at a high concentration, preferably 99% or more.

In the standard state, the mixed reaction gas is preferably passed on the catalyst at SV of 10 to 15,000 hr⁻¹, more preferably from 300 to 8,000 hr⁻¹.

The reaction method is not particularly limited and any known method, for example, fixed bed or fluidized bed, may be employed. A fixed bed where the above-described catalyst is packed in an anticorrosive reaction tube is preferably used and this is advantageous in view of practical use.

The present invention is further illustrated below by referring to Examples, however, these Examples only describe the outline of the present invention and the present invention should not be construed as being limited to these Examples.

Pretreatment of Support

In all Examples, the support used was pretreated by drying it in an air at 110° C. for 4 hours.

Use of Water

In all Examples, the water used was deionized water.

Use of Support

In all Examples, the support used was a silica support [BET specific surface area: 148 m²/g, bulk density: 405 g/l, 5 mmφ].

Use of Raw Material Compounds

The aqueous hydrochloric acid (hereinafter referred to as “HCl”) solution of sodium chloropalladate (Na₂PdCl₄] and the aqueous nitric acid solution of palladium nitrate [Pd(NO₃)₂] used in Examples are products produced by N.E. Chemcat Corporation. The silicotungstic acid hexacosahydrate [H₄SiW₁₂O₄₀·26H₂O] is a product produced by Nippon Inorganic Colour & Chemical Co., Ltd.

Components in Each Catalyst

The elemental analysis of metal elements and heteropolyacids contained in the catalysts for the production of acetic acid obtained in Example 1 and Comparative Example 1 was performed as follows. Each catalyst for the production of acetic acid was heat-treated under pressure and thereby dissolved in aqua regia and/or a mixed solution of hydrofluoric acid and aqua regia, and respective components were completely extracted and measured by ICP (SPS-1700, manufactured by Seiko Instruments Inc.). The mass % of each component in the catalyst is shown.

EXAMPLE 1

Sodium chloropalladate (3.56 g) and zinc chloride [ZnCl₂, produced by Wako Pure Chemical Industries, Ltd.] (54 mg) were mixed and added with deionized water to prepare 45 ml of an aqueous solution (Solution A). A silica support (40 g) was impregnated with Solution A to absorb the entire amount of the solution. Subsequently, the support was added to an aqueous solution (90 ml) of sodium metasilicate nonahydrate (Na₂SiO₃·9H₂O, produced by Wako Pure Chemical Industries, Ltd.] (8.0 g) and left standing at room temperature for 20 hours. To this solution, hydrazine monohydrate [N₂H₄·H₂O, produced by Wako Pure Chemical Industries, Ltd.] (6.5 g) was added and after gently stirring it, the solution was left standing at room temperature for 4 hours to cause reduction into metal palladium. Thereafter, the catalyst was collected by filtration, subjected to decantation, transferred to a glass column with a stop cock, washed by passing therethrough pure water for 40 hours, and then dried at 110° C. for 4 hours in an air stream to obtain a metal palladium-supported catalyst containing Zn.

Then, 45 ml of an aqueous solution having dissolved therein sodium tellurite [Na₂TeO₃, produced by Wako Pure Chemical Industries, Ltd.] (72 mg) was prepared (Solution B). The metal palladium-supported catalyst prepared above was impregnated with Solution B to absorb the entire amount of the solution, and then dried at 110° C. for 4 hours in an air stream to obtain a metal palladium-supported catalyst containing Zn and Te.

Furthermore, silicotungstic acid hexacohydrate (20.7 g) and an aqueous palladium nitrate solution (0.067 g as Pd) were made into a uniform aqueous solution and added with deionized water up to 45 ml (Solution C). The metal palladium-supported catalyst containing Zn and Te prepared above was impregnated with Solution C to absorb the entire amount of the solution, and then dried at 110° C. for 4 hours in an air stream to obtain Catalyst 1 for the production of acetic acid.

As a result of ICP analysis, it was confirmed that 1.73% of Pd, 0.59% of Au, 0.09% of Zn, 0.13% of Te, 22.9% of W and 0.09% of Mo were contained in the catalyst.

### COMPARATIVE EXAMPLE 1

Sodium chloropalladate (3.80 g) and zinc chloride [ZnCl₂, produced by Wako Pure Chemical Industries, Ltd.] (54 mg) were mixed and added with deionized water to prepare 45 ml of an aqueous solution (Solution A). A silica support (40 g) was impregnated with Solution A to absorb the entire amount of the solution. Subsequently, the support was added to an aqueous solution (90 ml) of sodium metasilicate nonahydrate [Na₂SiO₃·9H₂O, produced by Wako Pure Chemical Industries, Ltd.] (8.0 g) and left standing at room temperature for 20 hours. To this solution, hydrazine monohydrate [N₂H₄·H₂O, produced by Wako Pure Chemical Industries, Ltd.] (6.5 g) was added and after gently stirring it, the solution was left standing at room temperature for 4 hours to cause reduction into metal palladium. Thereafter, the catalyst was collected by filtration, subjected to decantation, transferred to a glass column with a stop cock, washed by passing therethrough pure water for 40 hours, and then dried at 110° C. for 4 hours in an air stream to obtain a metal palladium-supported catalyst containing Zn.

Then, 45 ml of an aqueous solution having dissolved therein sodium tellurite [Na₂TeO₃, produced by Wako Pure Chemical Industries, Ltd.] (72 mg) was prepared (Solution B). The metal palladium-supported catalyst prepared above was impregnated with Solution B to absorb the entire amount of the solution, and then dried at 110° C. for 4 hours in an air stream to obtain a metal palladium-supported catalyst containing Zn and Te.

Furthermore, silicotungstic acid hexacohydrate (20.7 g) was formed into a uniform aqueous solution and measured up to 45 ml (Solution C). The metal palladium-supported catalyst containing Zn and Te prepared above was impregnated with Solution C to absorb the entire amount of the solution, and then dried at 110° C. for 4 hours in an air stream to obtain Catalyst 2 for the production of acetic acid.

As a result of ICP analysis, it was confirmed that 1.72% of Pd, 0.59% of Au, 0.09% of Zn, 0.14% of Te, 23.0% of W and 0.09% of Mo were contained in the catalyst.

### EXAMPLE 2 AND COMPARATIVE EXAMPLE 2

Catalyst 1 for the production of acetic acid and Catalyst 2 for the production of acetic acid obtained in Example 1 and Comparative Example 1 each in 5 ml was packed in an SUS316-made reaction tube (inner diameter: 25 mm) without diluting the catalyst. A gas obtained by mixing ethylene:oxygen:water:nitrogen at a volume ratio of 10:6:15:69 was introduced at a space velocity of 1,800 hr⁻¹ by setting the reaction peak temperature of the catalytic layer to 220° C. and the reaction pressure to 0.8 MPa (gauge pressure) to cause a reaction for obtaining acetic acid from ethylene and oxygen.

The analysis in the reaction was performed as follows. The entire amount of the outlet gas passed through the catalyst-packed layer was cooled and the entire amount of the condensed reaction solution collected was recovered and analyzed by gas chromatography. As for the uncondensed gas remaining without undergoing condensation, the entire amount of the uncondensed gas outflowing within the sampling time was measured, a part thereof was taken out and the composition was analyzed by gas chromatography. The produced gas was cooled and after the cooling, the condensed solution and gas components were each analyzed by gas chromatography (GC-14B, manufactured by Shimadzu Corporation, FID detector: capillary column TC-WAX (length: 30 m, inner diameter: 0.25 mm, film thickness: 0.25 μm)).

The catalytic activity was calculated as the mass (space time yield STY, unit: g/hlcat) of acetic acid produced per volume of catalyst (liter) per hour.

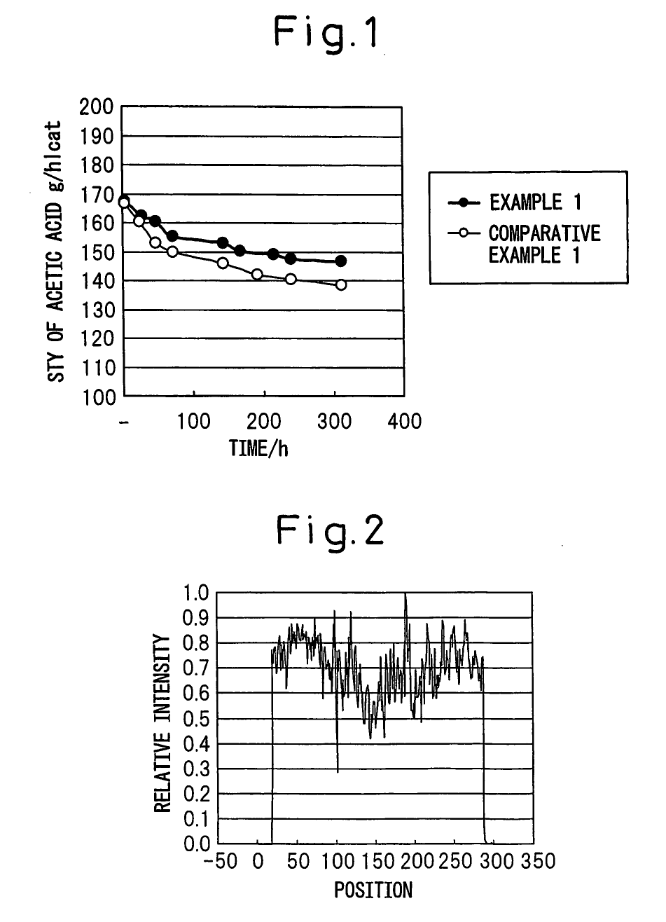

FIG. 1 shows the reaction results.

Measurement of Distribution of Silica (Support), Palladium and Heteropolyacid (Tungsten) by EPMA

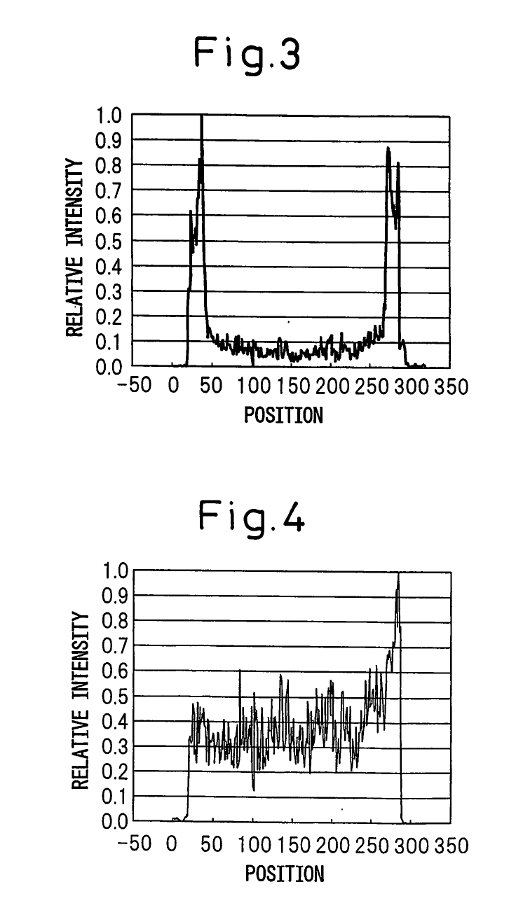

The obtained catalyst for the production of acetic acid was embedded in a resin and then polished to obtain a sample and this sample was subjected to plane analysis of the cross section of the support particle by using EPMA (JXA-8900, manufactured by JEOL Ltd.) according to the following procedure and measurement conditions. The obtained plane analysis was processed into linear analysis data, and FIGS. 2 and 3 show the results obtained.

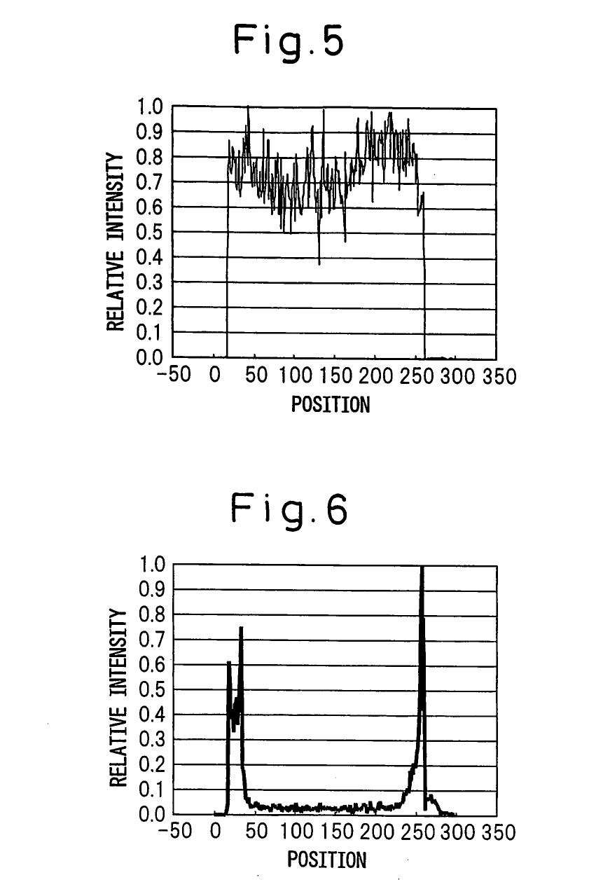

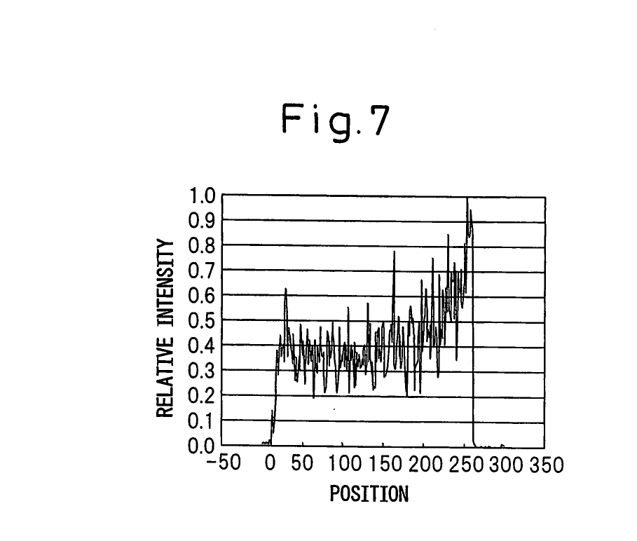

Also, FIG. 4 is a chart showing the EPMA analysis results of tungsten in the catalyst for the production of acetic acid obtained in Example 1, FIG. 5 is a chart showing the EPMA analysis results of Si in the catalyst for the production of acetic acid obtained in Comparative Example 1, FIG. 6 is a chart showing the EPMA analysis results of Pd in the catalyst for the production of acetic acid obtained in Comparative Example 1, and FIG. 7 is a chart showing the EPMA analysis results of tungsten in the catalyst for the production of acetic acid obtained in Comparative Example 1.

Pretreatment

Embedding in Resin:

Cold embedding resin No. 105 produced by Marumoto Struers K. K. was used by mixing therewith a hardening agent for No. 105.

Cutting:

The sample was cut by an Isomet (a wet diamond cutter). For the refrigerant, a solvent in which a heteropolyacid and/or a heteropolyacid salt does not dissolve, such as hexane, was selected.

Vapor Deposition:

The substance vapor-deposited was platinum.

EPMA Analysis

X-Ray Detector:
wavelength dispersion-type detector (WDS)

Acceleration voltage: 15 kV

Irradiation current: 1×10⁻⁷ A

### INDUSTRIAL APPLICABILITY

As described in the foregoing pages, it is apparent that when a catalyst for the production of acetic acid obtained by a production process comprising loading palladium in at least two parts is used, which is a supported catalyst comprising (a) palladium and (b) at least one compound selected from the group consisting of heteropolyacids and salts thereof, high productivity of acetic acid can be obtained.

1. A process for producing a catalyst for the production of acetic acid, the catalyst being a supported catalyst which is used in a process for producing acetic acid by reacting ethylene and oxygen in a gas phase and comprises (a) palladium and (b) at least one compound selected from the group consisting of heteropolyacids and salts thereof, the process comprising loading palladium in parts and through at least two steps.

2. The process for producing a catalyst for the production of acetic acid as claimed in claim 1, which comprises the following first and second steps:
First Step:
a step of loading (a) palladium on a support to obtain a palladium-supported catalyst;
Second Step:
a step of loading (a) palladium and (b) at least one compound selected from the group consisting of heteropolyacids and salts thereof on the palladium-supported catalyst obtained in the first step to obtain a catalyst for the production of acetic acid.

3. A process for producing a catalyst for the production of acetic acid, the catalyst being a supported catalyst which is used in a process for producing acetic acid by reacting ethylene and oxygen in a gas phase and comprises (a) palladium, (b) at least one compound selected from the group consisting of heteropolyacids and salts thereof and (c) at least one element selected from the group consisting of Sn, Pb, Bi, Sb and Te, the process comprising loading palladium in parts and through at least two steps.

4. The process for producing a catalyst for the production of acetic acid as claimed in claim 3, which comprises the following first and second steps:
First Step:
a step of loading (a) palladium and (c) at least one element selected from the group consisting of Sn, Pb, Bi, Sb and Te on a support to obtain a palladium-supported catalyst;
Second Step:
a step of loading (a) palladium and (b) at least one compound selected from the group consisting of heteropolyacids and salts thereof on the palladium-supported catalyst containing an element of the group (c) obtained in the first step to obtain a catalyst for the production of acetic acid.

5. The process for producing a catalyst for the production of acetic acid as claimed in claim 3, which comprises the following first and second steps:
First Step:
a step of loading (a) palladium on a support to obtain a palladium-supported catalyst;
Second Step:
a step of loading (a) palladium, (b) at least one compound selected from the group consisting of heteropolyacids and salts thereof and (c) at least one element selected from the group consisting of Sn, Pb, Bi, Sb and Te on the palladium-supported catalyst obtained in the first step to obtain a catalyst for the production of acetic acid.

6. The process for producing a catalyst for the production of acetic acid as claimed in claim 3, which comprises the following first, second and third steps:
First Step:
a step of loading (a) palladium on a support to obtain a palladium-supported catalyst;
Second Step:
a step of loading (c) at least one element selected from the group consisting of Sn, Pb, Bi, Sb and Te on the palladium-supported catalyst obtained in the first step to obtain a palladium-supported catalyst containing an element of the group (c);
Third Step:
a step of loading (a) palladium and (b) at least one compound selected from the group consisting of heteropolyacids and salts thereof on the palladium-supported catalyst containing an element of the group (c) obtained in the second step to obtain a catalyst for the production of acetic acid.

7. A process for producing a catalyst for the production of acetic acid, the catalyst being a supported catalyst which is used in a process for producing acetic acid by reacting ethylene and oxygen in a gas phase and comprises (a) palladium, (b) at least one compound selected from the group consisting of heteropolyacids and salts thereof, (c) at least one element selected from the group consisting of Sn, Pb, Bi, Sb and Te and (d) at least one element selected from the group consisting of Cr, Mn, Fe, Ru, Co, Cu, Au and Zn, the process comprising loading palladium in parts and through at least two steps.

8. The process for producing a catalyst for the production of acetic acid as claimed in claim 7, which comprises the following first and second steps:
First Step:
a step of loading (a) palladium, (c) at least one element selected from the group consisting of Sn, Pb, Bi, Sb and Te and (d) at least one element selected from the group consisting of Cr, Mn, Fe, Ru, Co, Cu, Au and Zn on a support to obtain a palladium-supported catalyst;
Second Step:
a step of loading (a) palladium and (b) at least one compound selected from the group consisting of heteropolyacids and salts thereof on the palladium-supported catalyst containing an element of the group (c) and an element of the group (d) obtained in the first step to obtain a catalyst for the production of acetic acid.

9. The process for producing a catalyst for the production of acetic acid as claimed in claim 7, which comprises the following first and second steps:
First Step:
a step of loading (a) palladium and (c) at least one element selected from the group consisting of Sn, Pb, Bi, Sb and Te on a support to obtain a palladium-supported catalyst;
Second Step:
a step of loading (a) palladium, (b) at least one compound selected from the group consisting of heteropolyacids and salts thereof and (d) at least one element selected from the group consisting of Cr, Mn, Fe, Ru, Co, Cu, Au and Zn on the palladium-supported catalyst containing an element of the group (c) obtained in the first step to obtain a catalyst for the production of acetic acid.

10. The process for producing a catalyst for the production of acetic acid as claimed in claim 7, which comprises the following first and second steps:
First Step:
a step of loading (a) palladium and (d) at least one element selected from the group consisting of Cr, Mn, Fe, Ru, Co, Cu, Au and Zn on a support to obtain a palladium-supported catalyst;
Second Step:
a step of loading (a) palladium, (b) at least one compound selected from the group consisting of heteropolyacids and salts thereof and (c) at least one element selected from the group consisting of Sn, Pb, Bi, Sb and Te on the palladium-supported catalyst containing an element of the group (d) obtained in the first step to obtain a catalyst for the production of acetic acid.

11. The process for producing a catalyst for the production of acetic acid as claimed in claim 7, which comprises the following first and second steps:
First Step:
a step of loading (a) palladium on a support to obtain a palladium-supported catalyst;
Second Step:
a step of loading (a) palladium, (b) at least one compound selected from the group consisting of heteropolyacids and salts thereof, (c) at least one element selected from the group consisting of Sn, Pb, Bi, Sb and Te and (d) at least one element selected from the group consisting of Cr, Mn, Fe, Ru, Co, Cu, Au and Zn on the palladium-supported catalyst obtained in the first step to obtain a catalyst for the production of acetic acid.

12. The process for producing a catalyst for the production of acetic acid as claimed in claim 7, which comprises the following first, second and third steps:
First Step:
a step of loading (a) palladium and (d) at least one element selected from the group consisting of Cr, Mn, Fe, Ru, Co, Cu, Au and Zn on a support to obtain a palladium-supported catalyst;
Second Step:
a step of loading (c) at least one element selected from the group consisting of Sn, Pb, Bi, Sb and Te on the palladium-supported catalyst containing an element of the group (d) obtained in the first step to obtain a palladium-supported catalyst containing an element of the group (c) and an element of the group (d);
Third Step:
a step of loading (a) palladium and (b) at least one compound selected from the group consisting of heteropolyacids and salts thereof on the palladium-supported catalyst containing an element of the group (c) and an element of the group (d) obtained in the second step to obtain a catalyst for the production of acetic acid.

13. The process for producing a catalyst for the production of acetic acid as claimed in claim 7, which comprises the following first, second and third steps:
First Step:
a step of loading (a) palladium on a support to obtain a palladium-supported catalyst;
Second Step:
a step of loading (c) at least one element selected from the group consisting of Sn, Pb, Bi, Sb and Te on the palladium-supported catalyst obtained in the first step to obtain a palladium-supported catalyst containing an element of the group (c);
Third Step:
a step of loading (a) palladium, (b) at least one compound selected from the group consisting of heteropolyacids and salts thereof and (d) at least one element selected from the group consisting of Cr, Mn, Fe, Ru, Co, Cu, Au and Zn on the palladium-supported catalyst containing an element of the group (c) obtained in the second step to obtain a catalyst for the production of acetic acid.

14. A process for producing a catalyst for the production of acetic acid, the catalyst being a supported catalyst which is used in a process for producing acetic acid by reacting ethylene and oxygen in a gas phase and comprises (a) palladium, (b) at least one compound selected from the group consisting of heteropolyacids and salts thereof, (c) at least one element selected from the group consisting of Sn, Pb, Bi, Sb and Te, (d) at least one element selected from the group consisting of Cr, Mn, Fe, Ru, Co, Cu, Au and Zn and (e) at least one element selected from the group consisting of V and Mo, the process comprising loading palladium in parts and through at least two steps.

15. The process for producing a catalyst for the production of acetic acid as claimed in claim 14, which comprises the following first and second steps:
First Step:
a step of loading (a) palladium, (c) at least one element selected from the group consisting of Sn, Pb, Bi, Sb and Te and (d) at least one element selected from the group consisting of Cr, Mn, Fe, Ru, Co, Cu, Au and Zn on a support to obtain a palladium-supported catalyst;
Second Step:
a step of loading (a) palladium, (b) at least one compound selected from the group consisting of heteropolyacids and salts thereof and (e) at least one element selected from the group consisting of V and Mo on the palladium-supported catalyst containing an element of the group (c) and an element of the group (d) obtained in the first step to obtain a catalyst for the production of acetic acid.

16. The process for producing a catalyst for the production of acetic acid as claimed in claim 14, which comprises the following first and second steps:
First Step:
a step of loading (a) palladium and (c) at least one element selected from the group consisting of Sn, Pb, Bi, Sb and Te on a support to obtain a palladium-supported catalyst;
Second Step:
a step of loading (a) palladium, (b) at least one compound selected from the group consisting of heteropolyacids and salts thereof, (d) at least one element selected from the group consisting of Cr, Mn, Fe, Ru, Co, Cu, Au and Zn and (e) at least one element selected from the group consisting of V and Mo on the palladium-supported catalyst containing an element of the group (c) obtained in the first step to obtain a catalyst for the production of acetic acid.

17. The process for producing a catalyst for the production of acetic acid as claimed in claim 14, which comprises the following first and second steps:
First Step:
a step of loading (a) palladium and (d) at least one element selected from the group consisting of Cr, Mn, Fe, Ru, Co, Cu, Au and Zn on a support to obtain a palladium-supported catalyst;
Second Step:
a step of loading (a) palladium, (b) at least one compound selected from the group consisting of heteropolyacids and salts thereof, (c) at least one element selected from the group consisting of Sn, Pb, Bi, Sb and Te and (e) at least one element selected from the group consisting of V and Mo on the palladium-supported catalyst containing an element of the group (d) obtained in the first step to obtain a catalyst for the production of acetic acid.

18. The process for producing a catalyst for the production of acetic acid as claimed in claim 14, which comprises the following first and second steps:
First Step:
a step of loading (a) palladium on a support to obtain a palladium-supported catalyst;
Second Step:
a step of loading (a) palladium, (b) at least one compound selected from the group consisting of heteropolyacids and salts thereof, (c) at least one element selected from the group consisting of Sn, Pb, Bi, Sb and Te, (d) at least one element selected from the group consisting of Cr, Mn, Fe, Ru, Co, Cu, Au and Zn and (e) at least one element selected from the group consisting of V and Mo on the palladium-supported catalyst obtained in the first step to obtain a catalyst for the production of acetic acid.

19. The process for producing a catalyst for the production of acetic acid as claimed in claim 14, which comprises the following first, second and third steps:
First Step:
a step of loading (a) palladium and (d) at least one element selected from the group consisting of Cr, Mn, Fe, Ru, Co, Cu, Au and Zn on a support to obtain a palladium-supported catalyst;
Second Step:
a step of loading (c) at least one element selected from the group consisting of Sn, Pb, Bi, Sb and Te on the palladium-supported catalyst containing an element of the group (d) obtained in the first step to obtain a palladium-supported catalyst containing an element of the group (c) and an element of the group (d);
Third Step:
a step of loading (a) palladium, (b) at least one compound selected from the group consisting of heteropolyacids and salts thereof and (e) at least one element selected from the group consisting of V and Mo on the palladium-supported catalyst containing an element of the group (c) and an element of the group (d) obtained in the second step to obtain a catalyst for the production of acetic acid.

20. The process for producing a catalyst for the production of acetic acid as claimed in claim 14, which comprises the following first, second and third steps:
First Step:
a step of loading (a) palladium on a support to obtain a palladium-supported catalyst;
Second Step:
a step of loading (c) at least one element selected from the group consisting of Sn, Pb, Bi, Sb and Te on the palladium-supported catalyst obtained in the first step to obtain a palladium-supported catalyst containing an element of the group (c);
Third Step:
a step of loading (a) palladium, (b) at least one compound selected from the group consisting of heteropolyacids and salts thereof, (d) at least one element selected from the group consisting of Cr, Mn, Fe, Ru, Co, Cu, Au and Zn and (e) at least one element selected from the group consisting of V and Mo on the palladium-supported catalyst containing an element of the group (c) obtained in the second step to obtain a catalyst for the production of acetic acid.

21. The process for producing a catalyst for the production of acetic acid as claimed in claim 2, wherein the first step further comprises the following first-1, first-2 and first-3 steps:
First-1 Step:
a step of loading (a) a palladium compound on a support to obtain a palladium-supported catalyst;
First-2 Step:
a step of dipping the palladium-supported catalyst obtained in the first-1 step in an aqueous alkali solution;
First-3 Step:
a step of reducing the palladium-supported catalyst obtained in the first-2 step to obtain a metal palladium-supported catalyst.

22. The process for producing a catalyst for the production of acetic acid as claimed in claim 4, wherein the first step further comprises the following first-1, first-2 and first-3 steps:
First-1 Step:
a step of loading (a) a palladium compound and (c) at least one element selected from the group consisting of Sn, Pb, Bi, Sb and Te on a support to obtain a palladium-supported catalyst;
First-2 Step:
a step of dipping the palladium-supported catalyst containing an element of the group (c) obtained in the first-1 step in an aqueous alkali solution;
First-3 Step:
a step of reducing the palladium-supported catalyst containing an element of the group (c) obtained in the first-2 step to obtain a metal palladium-supported catalyst containing an element of the group (c).

23. The process for producing a catalyst for the production of acetic acid as claimed in claim 10, wherein the first step further comprises the following first-1, first-2 and first-3 steps:
First-1 Step:
a step of loading (a) a palladium compound and (d) at least one element selected from the group consisting of Cr, Mn, Fe, Ru, Co, Cu, Au and Zn on a support to obtain a palladium-supported catalyst;
First-2 Step:
a step of dipping the palladium-supported catalyst containing an element of the group (d) obtained in the first-i step in an aqueous alkali solution;
First-3 Step:
a step of reducing the palladium-supported catalyst containing an element of the group (d) obtained in the first-2 step to obtain a metal palladium-supported catalyst containing an element of the group (d).

24. The process for producing a catalyst for the production of acetic acid as claimed in claim 8, wherein the first step further comprises the following first-1, first-2 and first-3 steps:
First-1 Step:
a step of loading (a) a palladium compound, (c) at least one element selected from the group consisting of Sn, Pb, Bi, Sb and Te and (d) at least one element selected from the group consisting of Cr, Mn, Fe, Ru, Co, Cu, Au and Zn on a support to obtain a palladium-supported catalyst;
First-2 Step:
a step of dipping the palladium-supported catalyst containing an element of the group (c) and an element of the group (d) obtained in the first-1 step in an aqueous alkali solution;
First-3 Step:
a step of reducing the palladium-supported catalyst containing an element of the group (c) and an element of the group (d) obtained in the first-2 step to obtain a metal palladium-supported catalyst containing an element of the group (c) and an element of the group (d).

25. The process for producing a catalyst for the production of acetic acid as claimed in claim 1, wherein (b) the heteropolyacid or a salt thereof is selected from the following heteropolyacids and salts thereof:
1-12-phosphotungstic acid: H₃[PW₁₂O₄₀]·nH₂O
1-12-silicotungstic acid: H₄[SiW₁₂O₄₀]·nH₂O wherein n represents an integer of 0 to 40.

26. A catalyst for the production of acetic acid, which is obtained by the process for producing a catalyst for the production of acetic acid as set forth in claim 1.

27. A process for producing acetic acid, comprising reacting ethylene and oxygen in a gas phase in the presence of the catalyst for the production of acetic acid as set forth in claim 26 obtained by the process for producing a catalyst for the production of acetic acid.
